(19) United States
(12) Patent Application Publication
(10) Pub. No.: US 2011/0037564 A1
(43) Pub. Date: Feb. 17, 2011

(54) DATA-COMMUNICATION-PORT CONTROL DEVICE

(75) Inventors: Kwok Fong Wong, Hong Kong (HK); Pui Yi Ching, Hong Kong (HK)

Correspondence Address: SUGHRUE MION, PLLC, 2100 PENNSYLVANIA AVENUE, N.W., SUITE 800, WASHINGTON, DC, 20037, US

(73) Assignee: Shining Union Limited, Hong Kong (HK)

(21) Appl. No.: 12/827,523

(22) Filed: Jun. 30, 2010

(30) Foreign Application Priority Data
Aug. 14, 2009 (HK) 09107516.1

(51) Int. Cl. G06F 7/04

(52) U.S. Cl. 340/5.83

(57) ABSTRACT

A data-communication-port control device comprising: an input port; at least one output port; at least one electric control switch coupled between the input port and the output port to receive a switch control signal, and control the output port to be connected or disconnected; a fingerprint scan unit for acquiring a user' s fingerprint image; a storage unit for storing the fingerprint image and port information associated with the fingerprint image; a fingerprint matching unit connected between the fingerprint scan unit and the storage unit to retrieve whether there is any fingerprint image stored in the storage unit and matched with the fingerprint image acquired by the fingerprint scan unit, and if there is, acquiring the port information associated with the fingerprint image; a control unit connected between the fingerprint matching unit and the electric control switch for sending a connection signal to the electric control switch controlling the corresponding port in accordance with the port information. The invention effectively controls any illegal access of the user to the network through a control system independent of the network, while the user cannot dismiss the control through the network.

### CROSS-REFERENCE TO RELATED APPLICATIONS

The application claims the priority benefits of Hong Kong Short-Term patent Application No. 09107516.1 filed on Aug. 14, 2009, the contents of which are hereby incorporated by reference in its entirety.

### FIELD OF THE INVENTION

The present invention relates to the telecommunication field, and particularly to a data-communication-port control device.

### BACKGROUND OF THE INVENTION

Most prior art applications just connect a computer and a data modem, and control access of users to a network by means of software. However, such control by software is very easy to be dismissed, and users having no access authority can access the network by dismissing the controlling software.

### SUMMARY OF THE INVENTION

A propose of the invention is to address the problem that the user having no access authority accesses the network illegally.

The invention provides a data-communication-port control device, comprising: an input port; at least one output port; at least one electric control switch coupled between the input port and the at least one output port for receiving a switch control signal to control the output port to be connected or disconnected; a fingerprint scan unit for acquiring a user' s fingerprint image; a storage unit for storing the fingerprint image and port information associated with the fingerprint image; a fingerprint matching unit connected between the fingerprint scan unit and the storage unit for retrieving whether there is any fingerprint image stored in the storage unit which matching with the fingerprint image acquired by the fingerprint scan unit, and if there is, for acquiring the port information associated with the fingerprint image; a control unit connected between the fingerprint matching unit and the electric control switch for sending a connection signal to the electric control switch controlling the corresponding port in accordance with the port information; and a user registration unit connected the fingerprint scan unit and the storage unit for receiving a fingerprint image inputted through the fingerprint scan unit by user, creating correspondence between the fingerprint image and the output port, and storing the correspondence in the storage unit.

The invention effectively controls illegal accesses of the user to the network by a control system independent of the network, and the user cannot dismiss the control through the network.

### BRIEF DESCRIPTION OF THE DRAWINGS

In order to describe technical solutions of the embodiments in the present invention or the prior art in detail, the drawings used in describing the embodiments or the prior art will be simply described hereinafter. Obviously, the drawings in the following description are only several embodiments of the invention, and, other drawings can be obtained in accordance with these drawings without any creative efforts to those skilled in the art.

FIG. 1 is a structural diagram of a data-communication-port control device of a first embodiment of the invention.

FIG. 2 is a structural diagram of a user registration unit of a second embodiment of the invention.

FIG. 3 is a structural diagram of a data-communication-port control device of a third embodiment of the invention.

### DETAILED DESCRIPTION OF THE INVENTION

Hereinafter, solutions of the embodiments in the invention will be described clearly and fully with reference to the accompanying drawings, which are obviously only part embodiments of the invention, rather than all the embodiments. According to the embodiments of the invention, all the other embodiments made by the skilled in the art without any creative effort are all within the scope of the invention.

The invention is intended mainly for providing a device controlling data communication port on the basis of the fingerprint. In the prior art, it is just to connect a computer with a data modem and control an access to a network by software. Fingerprint identification is incorporated to control the network access by hardware in the device of the invention, thereby preventing the access controlling from being dismissed by the way of software. A matching method of fingerprint is used in the invention to authenticate an authorized user and the data communication port is opened only for the authorized user. By combining the data-communication-port control device of the invention with a modem, a switch, a hub or a router, the access control will be significantly enhanced by the way of hardware and the identity of the actual user will be recoginized. Furthermore, the device provided by the invention can further send an alarm signal when an unauthorized user attempts to open the data communication port via the fingerprint scanning. When an unauthorized user attempts to scan his/her unregistered fingerprint with the device of the invention, a buzzer makes a sound to warn the user, for example.

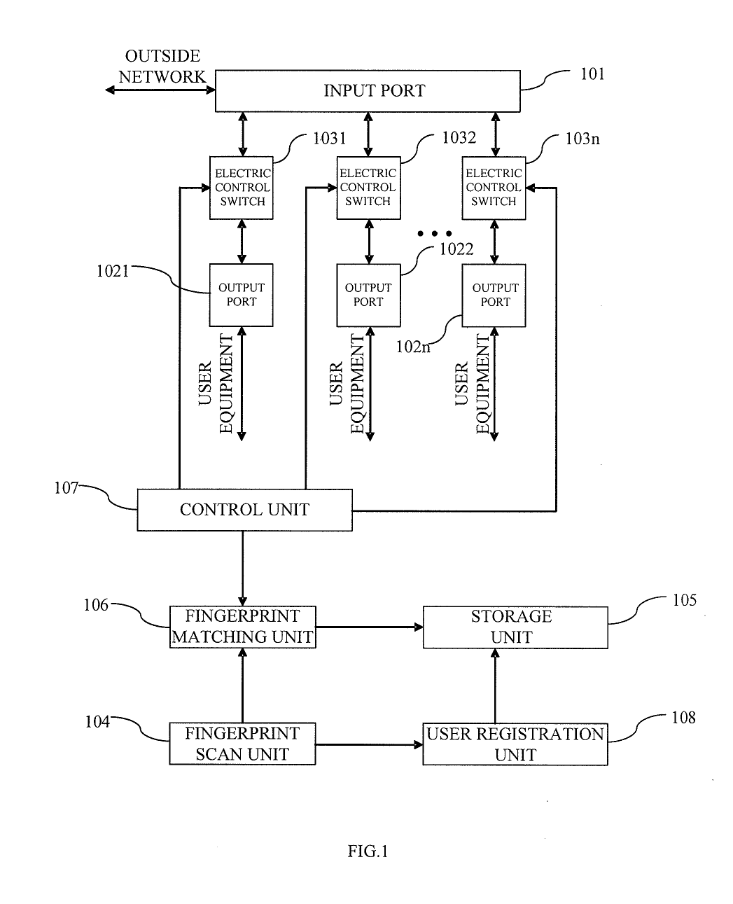

As shown in FIG. 1, the embodiments of the invention provide a data-communication-port control device, which includes: an input port 101 for connecting an outside network; at least one output port 1021 to 102n, for connecting a user equipment; at least one electric control switch 1031 to 103n coupled between the input port 101 and the output port 1021 to 102n, which correspond to the output port 1021 to 102n one-to-one for receiving a switch control signal to control connection or disconnection to the output port; a fingerprint scan unit 104, for scanning a fingerprint of a user to acquire a fingerprint image; a storage unit 105, for storing the fingerprint image and a port information associated with the fingerprint image; a fingerprint matching unit 106 connected to the fingerprint scan unit 104 and the storage unit 105, for retrieving whether there is any fingerprint image stored in the storage unit 105 matching with the fingerprint image acquired by the fingerprint scan unit 104, and if there is, for acquiring the port information associated with the fingerprint image; a control unit 107 connected to the fingerprint matching unit 106 and the electric control switch 1031 to 103n for sending a connection signal to the electric control switch controlling the corresponding port in accordance with the port information, and for sending a disconnection signal to the individual electric control switch when a disconnection between the corresponding output port connected to the input port by virtue of the electric control switch and the user equipment is detected; and a user registration unit 108 connected to the fingerprint scan unit 104 and the storage unit 105 for receiving a fingerprint image inputted through the fingerprint scan unit 104 by the user, creating a correspondence between the fingerprint image and the output port and storing the correspondence in the storage unit 105.

Note that although the case with a plurality of output ports and a plurality of electric control switches is illustrated, the embodiment including only one output port and one electric control switch should also be within the scope of the invention.

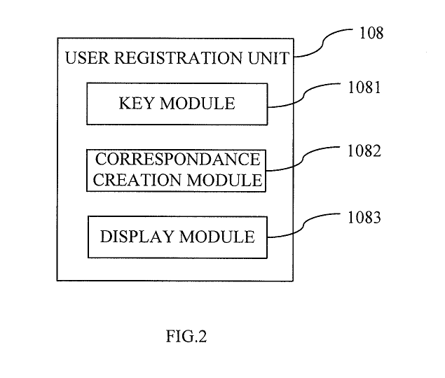

As shown in FIG. 2, the user registration unit further comprises: a key module 1081 for generating a user registration signal when pressed by the user; a correspondence creation module 1082, for when receiving the user registration signal, receiving the fingerprint image acquired by the fingerprint scan unit 104, and selecting an output port which has no correspondence with a fingerprint image, to create a correspondence with the fingerprint image acquired by the fingerprint scan unit 104 at this time, and storing the correspondence in the storage unit 105; and a display module 1083 for displaying the output port that has created the correspondence with the fingerprint image at this time.

After a user presses the key module 1081, a fingerprint image is input by the fingerprint scan unit 104, and the correspondence creation module 1082 can determine which port has not created a correspondence with the fingerprint image according to the correspondence stored in the storage unit, for example, to select the output port 1022 to create a correspondence with the input fingerprint image and store the correspondence in the storage unit 105. When the user wants to use the network, he/she can scan a fingerprint image on the fingerprint scan unit 104, and the fingerprint matching unit 106 acquires the fingerprint image and retrieves a fingerprint image matching with the fingerprint image acquired by the fingerprint scan unit 104 in the storage unit 105, so as to acquire that the output port associated with the fingerprint image is 1022. The controlling unit 107 controls the electric control switch 1032 corresponding to the output port 1022 to send a connection signal, and the electric control switch 1032 is closed, then the user equipment can be connected to the network. When the control unit 107 detects a disconnection between the port 1022 connected to the input port by virtue of the electric control switch 1032 and the user equipment, it sends a disconnection signal to the electric control switch 1032 and in turn the port 1022 is locked.

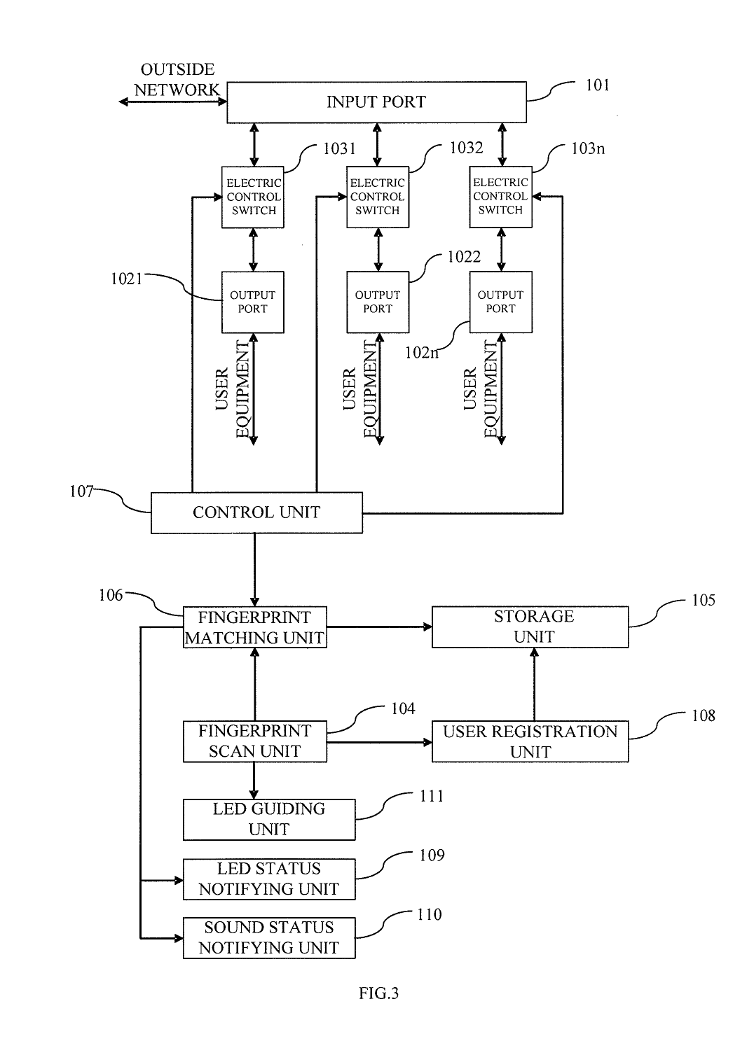

As shown in FIG. 3, furthermore, in another embodiment of the present invention, the data-communication-port control device further comprises a LED status notifying unit 109 connected to the fingerprint matching unit 106, for indicating status of the fingerprint matching. The LED status notifying unit 109 may have LEDs with different colors, and controls a green LED to light to notify of a success of the fingerprint image reorganization when the input fingerprint image matches (the fingerprint matching unit 106 sends a signal of matching success or failure to the LED notifying unit 109) and controls a red LED to light to notify of a failure of the fingerprint image reorganization when the input fingerprint image does not match. A sound status notifying unit 110 is connected to the fingerprint matching unit 106 for notifying of the status or the result of the fingerprint scanning. The sound status notifying unit 110 includes a buzzer or a speaker, controls the buzzer or the speaker to make a short sound to indicate the success of the fingerprint image reorganization when the input fingerprint image matches (the fingerprint matching unit 106 sends a signal of matching success or failure to the sound status notifying unit 110), and controls the buzzer or the speaker to make a long warning sound to indicate the failure of the fingerprint image reorganization when the input fingerprint image does not match. A LED guiding unit 111 is connected to the fingerprint scan unit 104 to guide the user the position and the direction of scanning during the fingerprint scanning. The LED guiding unit 111 includes a plurality of LEDs which are disposed in the vicinity of the fingerprint scan unit 104 and arranged along the direction of the fingerprint scanning. When the fingerprint scan unit 104 is powered, the LED guiding unit 111 controls these LEDs to light in order along the direction of the fingerprint scanning to guide the user the position and the direction of the scanning.

The data-communication-port control device of the embodiment of the invention further comprises a modem, a switch, a hub or a router. The input port and the output port are the input port and the output port of the modem, switch, hub or router. Those skilled in the art can understand how to implement the data-communication-port control device comprising the modem, the switch, the HUB or the router according to the disclosure of the invention, so it is omitted herein.

The invention effectively controls any illegal access of the user to the network through a control system independent of the network, while the user cannot dismiss the control through the network.

While the object, solution and advantages of the invention have been described in detail with the foregoing embodiments, it should be understood that the description above includes only some specific embodiments of the invention, without limiting the scope of the invention. Various modifications, alterations and improving should be included within the scope of the invention within the spirit and the principle of the invention.

What is claimed is:

1. A data-communication-port control device, characterized by the device comprising:
an input port for connecting an outside network;
at least one output port for connecting a user equipment;
at least one electric control switch coupled between the input port and the at least one output port, which corresponds to the at least one output port one-to-one, for receiving a switch control signal to control connection or disconnection between the input port and the respective output port;
a fingerprint scan unit for scanning a fingerprint of a user to acquire a fingerprint image;
a storage unit for storing the fingerprint image and a port information associated with the fingerprint image;
a fingerprint matching unit connected between the fingerprint scan unit and the storage unit, for retrieving whether there is a fingerprint image stored in the storage unit which matches with the fingerprint image acquired by the fingerprint scan unit, and, if there is, for acquiring the port information associated with the fingerprint image;
a controlling unit connected to the fingerprint matching unit and the electric control switch, in which the controlling unit is used for sending a connection signal to the individual electric control switch controlling the respective output port in accordance with the port information, and for sending a disconnection signal to the individual electric control switch when the disconnection between the corresponding output port connected to the input port by virtue of the individual electric control switch and the user equipment is detected; and
a user registration unit connected to the fingerprint scan unit and the storage unit, for receiving the fingerprint image input through the fingerprint scan unit by the user, creating a correspondence between the fingerprint image and the output port, and storing the correspondence in the storage unit.

2. The data-communication-port control device according to claim 1, wherein the user registration unit comprises:
a key module for generating a user registration signal when pressed by the user;
a correspondence creation module for, when receiving the user registration signal, receiving the fingerprint image acquired by the fingerprint scan unit and selecting an output port that has not created a correspondence with the fingerprint image to create a correspondence with the fingerprint image acquired by the fingerprint scan unit at this time, and storing the correspondence in the storage unit; and
a display module for displaying the output port that has created the correspondence with the fingerprint image at this time.

3. The data-communication-port control device according to claim 1, wherein the device further comprises a LED status notifying unit connected to the fingerprint matching unit, for indicating status of the fingerprint matching.

4. The data-communication-port control device according to claim 1, wherein the device further comprises a sound status notifying unit connected to the fingerprint matching unit, for notifying of status or result of the fingerprint scanning.

5. The data-communication-port control device according to claim 1, wherein the device further comprises a LED guiding unit connected to the fingerprint scan unit, for guiding the user position and direction of the scanning during the fingerprint scanning.

6. The data-communication-port control device according to claim 1, wherein the device further comprises a modem, a switch, a hub or a router, the input port and the output port being the input port and the output port of the modem, the switch, the hub or the router.
